(19) United States
(12) Patent Application Publication
(10) Pub. No.: US 2026/0371101 A1
(43) Pub. Date: Nov. 19, 2026

(54) INFORMATION TRANSMISSION METHOD AND APPARATUS, AND STORAGE MEDIUM

(71) Applicant: Beijing Xiaomi Mobile Software Co., Ltd., Beijing (CN)

(72) Inventor: Xiaolong LI, Beijing (CN)

(73) Assignee: Beijing Xiaomi Mobile Software Co., Ltd., Beijing (CN)

(21) Appl. No.: 19/144,122

(22) PCT Filed: Dec. 28, 2022
(86) PCT No.: PCT/CN2022/142923

§ 371 Date: Jun. 27, 2025

(51) Int. Cl. H04W 16/24

(52) U.S. Cl. CPC H04W 16/24

(57) ABSTRACT

Provided in the present disclosure are an information transmission method and apparatus, and a storage medium. The method comprises: sending terrestrial network (TN) region information to a terminal, wherein the TN region information is information of a region where there is TN network coverage. In the present disclosure, a network-side device can send TN region information to a terminal, such that the terminal executes, on the basis of the TN region information, a TN frequency measurement when the terminal is in a TN region, thereby effectively reducing the power consumption of the terminal.

### CROSS-REFERENCE TO RELATED APPLICATIONS

This application is a national stage of International Application No. PCT/CN2022/142923, filed on Dec. 28, 2022, which is hereby incorporated by reference in its entirety.

### TECHNICAL FIELD

The present disclosure relates to the field of communication, and in particular, to an information transmission method and apparatus, and a storage medium.

### BACKGROUND

At present, a non-terrestrial network (NTN) and a terrestrial network (TN) may have same or different frequencies. For a terminal reselected from an NTN cell to a TN cell, intra-frequency measurement and inter-frequency measurement may be performed. In addition, for cell reselection between the NTN cell and the TN cell, a network side device may configure a higher priority for the frequency of the TN, and in this case, the UE needs to measure the frequency of the TN in priority.

When a serving cell of the terminal is the NTN cell, considering a large coverage area of the NTN cell, there may not be any TN cell in the NTN cell, or there may be few TN cells in the NTN cell, that is, there may not be any TN cell around the terminal. If the frequency of the TN is configured with a higher priority, according to current protocols, even if there is no TN cell around the terminal, the terminal still needs to measure the frequency of the TN, which causes increased unnecessary power consumption of the terminal.

### SUMMARY

To solve problems in the related arts, embodiments of the present disclosure provide an information transmission method and apparatus, and a storage medium.

According to a first aspect of the embodiments of the present disclosure, an information transmission method is provided, performed by a network side device, including:
sending terrestrial network (TN) area information to a terminal, where the TN area information includes information of an area covered by a TN network.

Optionally, sending the TN area information to the terminal includes:
sending first TN area information corresponding to a first TN area to the terminal through a first system message; and/or
sending second TN area information corresponding to a second TN area to the terminal through a first radio resource control (RRC) message.

Optionally, the method further includes:
sending a first distance threshold to the terminal, where the first distance threshold is used by the terminal to determine, in the first TN area information, target TN area information that needs to be stored.

Optionally, sending the first distance threshold to the terminal includes:
sending the first distance threshold to the terminal through a second system message; and/or
sending the first distance threshold to the terminal through a second RRC message.

Optionally, the method further includes:
when the second TN area information is sent to the terminal through the first RRC message, sending validity indication information to the terminal, where the validity indication information indicates validity of the second TN area information.

Optionally, the method further includes:
receiving the validity indication information reported by the terminal.

Optionally, the validity indication information includes at least one of:
a valid duration of the second TN area information; or
a second distance threshold for determining a valid distance range of the second TN area information; where the second distance threshold is used by the terminal to determine a maximum movable distance value relative to a second specified location when the second TN area information is valid.

Optionally, the method further includes:
receiving terminal capability information reported by the terminal, where the terminal capability information indicates whether the terminal has capability of supporting a TN area.

The terminal capability information further indicates a quantity of TN areas supported by the terminal.

According to a second aspect of the embodiments of the present disclosure, an information transmission method is provided, performed by a terminal, including:
receiving terrestrial network (TN) area information sent by a network side device, where the TN area information includes information of an area covered by a TN network.

Optionally, receiving the TN area information sent by the network side device includes:
receiving first TN area information corresponding to a first TN area sent by the network side device through a first system message; and/or
receiving second TN area information corresponding to a second TN area sent by the network side device through a first radio resource control (RRC) message.

Optionally, the method further includes:
receiving a first distance threshold sent by the network side device, where the first distance threshold is used by the terminal to determine, in the first TN area information, target TN area information that needs to be stored.

Optionally, the method further includes:
determining a TN area with a first distance value from a first specified location being less than or equal to the first distance threshold as a target TN area; where the first specified location is a geographic location of the terminal when receiving the first TN area information, or the first specified location is a geographic location of the terminal when determining a first distance value; and
determining, in the first TN area information, TN area information corresponding to the target TN area as the target TN area information, and storing the target TN area information.

Optionally, receiving the first distance threshold sent by the network side device includes:
receiving the first distance threshold sent by the network side device through a second system message; and/or
receiving the first distance threshold sent by the network side device through a second RRC message.

Optionally, the method further includes:
receiving validity indication information sent by the network side device, where the validity indication information indicates validity of the second TN area information.

Optionally, the method further includes:
reporting the validity indication information to the network side device.

Optionally, the validity indication information includes at least one of:
a valid duration of the second TN area information; or
a second distance threshold for determining a valid distance range of the second TN area information; where the second distance threshold is used by the terminal to determine a maximum movable distance value relative to a second specified location when the second TN area information is valid.

Optionally, the method further includes:
determining that the second TN network area information is valid within the valid duration.

Optionally, the method further includes:
determining a range with a second distance value from the second specified location being less than or equal to the second distance threshold as the valid distance range; where the second specified location is a geographic location of the terminal when receiving the second TN area information, or the second specified location is a geographic location of the terminal when determining a second distance value; and
determining that the second TN area information is valid when moving within the valid distance range.

Optionally, determining that the second TN area information is valid includes:
determining that the second TN area information is available.

Optionally, the method further includes:
in response to receiving the first TN area information and the second TN area information, using the second TN area information.

Optionally, the method further includes:
in response to determining that the second TN area information is invalid, using the first TN area information.

Optionally, determining that the second TN area information is invalid includes:
determining that a valid duration of the second TN area information is exceeded; and/or
determining that a valid distance range of the second TN area information is exceeded.

Optionally, the method further includes:
reporting terminal capability information to the network side device, where the terminal capability information indicates whether the terminal has capability of supporting a TN area.

The terminal capability information further indicates a quantity of TN areas supported by the terminal.

According to a third aspect of the embodiments of the present disclosure, an information transmission apparatus is provided, applied to a base station, including:
a sending module, configured to send terrestrial network (TN) area information to a terminal.

According to a fourth aspect of the embodiments of the present disclosure, an information transmission apparatus is provided, applied to a terminal, including:
a receiving module, configured to receive terrestrial network (TN) area information sent by a network side device.

According to a fifth aspect of the embodiments of the present disclosure, a computer-readable storage medium is provided, storing a computer program, where the computer program is used for performing the information transmission method of any one of the above terminal side.

According to a sixth aspect of the embodiments of the present disclosure, a computer-readable storage medium is provided, storing a computer program, where the computer program is used for performing the information transmission method of any one of the above network side device.

According to a seventh aspect of the embodiments of the present disclosure, an information transmission device is provided, including:
a processor;
a memory for storing a processor-executable instruction;
where the processor is configured to perform the information transmission method according to any one of the above terminal side.

According to an eighth aspect of the embodiments of the present disclosure, an information transmission device is provided, including:
a processor;
a memory for storing a processor-executable instruction;
where the processor is configured to perform the information transmission method according to any one of the above network side device.

The technical solutions provided by the embodiments of the present disclosure may include following beneficial effects.

In the present disclosure, a network-side device can send TN area information to a terminal, such that the terminal performs, based on the TN area information, TN frequency measurement when the terminal is in a TN area, thereby effectively reducing power consumption of the terminal.

It shall be noted that the above general description and the following detailed description are examples and explanatory only and are not restrictive of the present disclosure.

### BRIEF DESCRIPTION OF DRAWINGS

The accompanying drawings, which are incorporated in and constitute a part of this specification, illustrate embodiments consistent with the present disclosure and, together with the description, serve to explain the principles of the present disclosure.

FIG. 1 is a schematic flowchart of an information transmission method according to an example embodiment.

FIG. 2A is a schematic flowchart of another information transmission method according to an example embodiment.

FIG. 2B is a schematic flowchart of another information transmission method according to an example embodiment.

FIG. 2C is a schematic flowchart of another information transmission method according to an example embodiment.

FIG. 3 is a schematic flowchart of another information transmission method according to an example embodiment.

FIG. 4A is a schematic flowchart of another information transmission method according to an example embodiment.

FIG. 4B is a schematic flowchart of another information transmission method according to an example embodiment.

FIG. 5 is a schematic flowchart of another information transmission method according to an example embodiment.

FIG. 6 is a schematic flowchart of another information transmission method according to an example embodiment.

FIG. 7A is a schematic flowchart of another information transmission method according to an example embodiment.

FIG. 7B is a schematic flowchart of another information transmission method according to an example embodiment.

FIG. 7C is a schematic flowchart of another information transmission method according to an example embodiment.

FIG. 8 is a schematic flowchart of another information transmission method according to an example embodiment.

FIG. 9A is a schematic flowchart of another information transmission method according to an example embodiment.

FIG. 9B is a schematic flowchart of another information transmission method according to an example embodiment.

FIG. 10 is a schematic flowchart of another information transmission method according to an example embodiment.

FIG. 11 is a schematic flowchart of another information transmission method according to an example embodiment.

FIG. 12 is a schematic flowchart of another information transmission method according to an example embodiment.

FIG. 13 is a schematic flowchart of another information transmission method according to an example embodiment.

FIG. 14 is a block diagram of an information transmission apparatus according to an example embodiment.

FIG. 15 is a block diagram of another information transmission apparatus according to an example embodiment.

FIG. 16 is a schematic structural diagram of an information transmission device according to an example embodiment of the present disclosure.

FIG. 17 is a schematic structural diagram of another information transmission device according to an example embodiment of the present disclosure.

### DETAILED DESCRIPTION

Example embodiments will be described in detail herein, examples of which are illustrated in the accompanying drawings. When following description refers to the drawings, unless otherwise indicated, same numerals in different drawings indicate same or similar elements. The implementations set forth in the following description of example embodiments do not represent all implementations consistent with the present disclosure. Instead, they are merely examples of apparatuses and methods consistent with aspects related to the present disclosure as recited in the appended claims.

The terminology used herein is for the purpose of describing particular embodiments only and is not intended to be limiting of the disclosure. The singular forms “a”, “said” and “the” used in the present disclosure and the appended claims are also intended to include plural forms, unless the context clearly indicates other meanings. It will also be understood that the term “and/or” as used herein refers to and encompasses any and all possible combinations of at least one of the associated listed items.

It should be understood that although the terms first, second, third, etc. may be used in the present disclosure to describe various information, the information should not be limited to these terms. These terms are only used to distinguish a same type of information from each other. For example, without departing from the scope of the present disclosure, “first information” may also be referred to as “second information”, and similarly, “second information” may also be referred to as “first information”. Depending on the context, the word “if” as used herein may be interpreted as “when” or “upon” or “in response to determining”.

The following describes the information transmission method provided in the present disclosure from a network side device first.

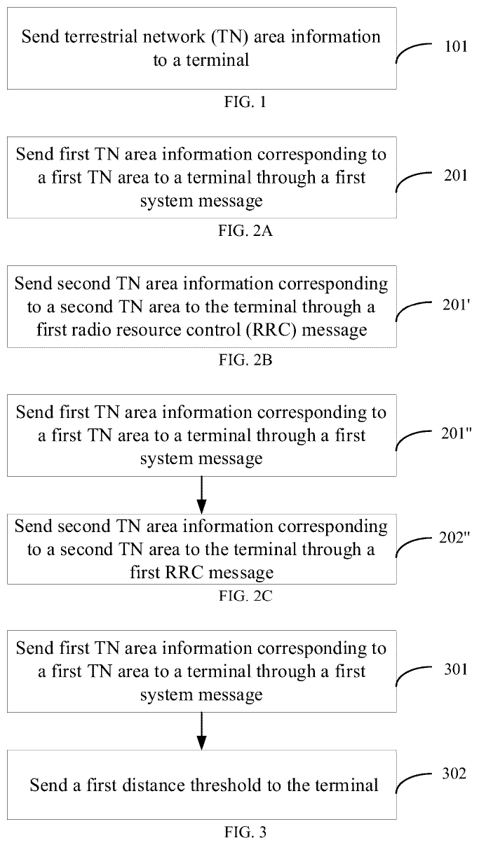

An embodiment of the present disclosure provides an information transmission method, referring to FIG. 1, FIG. 1 is a flowchart of an information transmission method according to an embodiment, which may be performed by a network side device, where the network side device includes, but is not limited to, a base station, a core network device in non-terrestrial network (NTN), and the method may include a following step.

In step 101, terrestrial network (TN) area information is sent to a terminal.

In an embodiment of the present disclosure, the TN area information may refer to related information of an area covered by the TN network. The network side device may send the TN area information configured for the terminal to the terminal, where the TN area information may include but is not limited to geographic location information of a TN area. The geographic location information may be represented by latitude and longitude, which is not limited in the present disclosure.

In a possible implementation, the TN area information may include geographic location information of a center point of each TN area and a radius of each TN area.

The terminal may use the center point as a circle center to determine a circular area by using a corresponding radius, and determine the circular area as a TN area.

In another possible implementation, the TN area information may include geographic location information of a plurality of location points located on a boundary of each TN area.

The terminal may connect the plurality of location points by using straight lines, and determine an obtained area as the TN area. That is, the network sends a plurality of pieces of location information to the terminal, and the terminal obtains the TN area information based on the plurality of pieces of location information.

The above is only an example description, and the TN area information may include other information for determining the TN area, which is not limited in the present disclosure.

In the above embodiments, the network-side device can send the TN area information to the terminal, such that the terminal performs, based on the TN area information, TN frequency measurement when the terminal is in the TN area, thereby effectively reducing power consumption of the terminal.

In some optional embodiments, referring to FIG. 2A, FIG. 2A is a flowchart of an information transmission method according to an embodiment, which may be performed by a network side device, where the network side device includes but is not limited to a base station, a core network device in an NTN, and the method may include a following step.

In step 201, first TN area information corresponding to a first TN area is sent to a terminal through a first system message.

In the embodiment of the present disclosure, the first system message may be a system information block (SIB), such as a SIBn, where n is a positive integer.

There may be a plurality of first TN areas, which is not limited in the present disclosure.

In other words, the network side device in the NTN may send, to the terminal through the first system message, the first TN area information corresponding to the first TN area configured for the terminal.

In a possible implementation, the first TN area information may include geographic location information of a center point of each first TN area and a radius of each first TN area.

In another possible implementation, the first TN area information may include geographic location information of a plurality of location points located on a boundary of each first TN area.

In the above embodiment, the network side device may send the first TN area information to the terminal through the first system message, so that the terminal performs TN frequency measurement when the terminal is in the corresponding first TN area, thereby effectively reducing power consumption of the terminal.

In some optional embodiments, referring to FIG. 2B, FIG. 2B is a flowchart of an information transmission method according to an embodiment, which may be performed by a network side device, where the network side device includes but is not limited to a base station, a core network device in an NTN, and the method may include a following step.

In step 201′, second TN area information corresponding to a second TN area is sent to the terminal through a first radio resource control (RRC) message.

In the embodiment of the present disclosure, considering a case that there may be a large number of the first TN areas, the network side device occupies plenty of signaling resources when sending the first TN area information to the terminal, and in order to reduce the occupation of the signaling resources of the network side, the network side device may select the first TN areas.

After establishing a radio resource control (RRC) connection to the terminal, the network side device may determine geographical location information of the terminal. Therefore, the network side device may select, based on the geographic location information of the terminal, some of the first TN areas that are located around the terminal, that is, select second TN areas, and further, the network side device may send, to the terminal through the first RRC message, the second TN area information corresponding to the second TN areas.

In a possible implementation, the second TN area information may include geographic location information of a center point of each second TN area and a radius of each second TN area.

In another possible implementation, the second TN area information may include geographic location information of a plurality of location points located on a boundary of each second TN area.

In the above embodiment, the network side device may send the second TN area information to the terminal through the first RRC message, so that the terminal performs TN frequency measurement when the terminal is in the corresponding second TN area, thereby effectively reducing power consumption of the terminal.

In some optional embodiments, referring to FIG. 2C, FIG. 2C is a flowchart of an information transmission method according to an embodiment, which may be performed by a network side device, where the network side device includes but is not limited to a base station, a core network device in an NTN, and the method may include following steps 201″ and 202″.

In step 201″, first TN area information corresponding to a first TN area is sent to a terminal through a first system message.

An implementation of step 201″ is similar to that of step 201, and details will not be repeated herein.

In step 202″, second TN area information corresponding to a second TN area is sent to the terminal through a first RRC message.

An implementation of step 202″ is similar to that of step 201′, and details will not be repeated herein.

In the above embodiment, the network side device may send the first TN area information to the terminal through the first system message, and further, after establishing the RRC connection to the terminal, the network side device sends the second TN area information to the terminal through the first RRC message, so that the terminal performs TN frequency measurement when the terminal is in the corresponding second TN area, thereby effectively reducing power consumption of the terminal.

In some optional embodiments, referring to FIG. 3, FIG. 3 is a flowchart of an information transmission method according to an embodiment, which may be performed by a network side device, where the network side device includes but is not limited to a base station, a core network device in an NTN, and the method may include following steps 301 and 302.

In step 301, first TN area information corresponding to a first TN area is sent to a terminal through a first system message.

In the embodiment of the present disclosure, the first system message may be a system information block (SIB), such as a SIBn, where n is a positive integer.

There may be a plurality of first TN areas, which is not limited in the present disclosure.

In other words, the network side device in the NTN may send, to the terminal through the first system message, the first TN area information corresponding to the first TN area configured for the terminal.

In step 302, a first distance threshold is sent to the terminal.

In an embodiment of the present disclosure, the first distance threshold is used by the terminal to determine, in the first TN area information, target TN area information that needs to be stored.

In the embodiment of the present disclosure, after the network side device sends the first TN area information to the terminal through the first system message, in order to reduce occupation of terminal resources, the network side device may further configure a first distance threshold for the terminal, and send the first distance threshold to the terminal, so that the terminal determines, in the received first TN area information, the target TN area information that needs to be stored by the terminal.

In a possible implementation, the network side device may send the first distance threshold to the terminal through a second system message.

Optionally, the second system message and the first system message may be a same SIB or different SIBs, for example, the first system message is SIB1, and the second system message may be SIBm, where m is greater than 1. For another example, both the first system message and the second system message are SIB1.

In another possible implementation, the network side device may send the first distance threshold to the terminal through a second RRC message.

Optionally, the second RRC message and the first RRC message are a same RRC message or different RRC messages, which is not limited in the present disclosure.

In the above embodiment, the network side device may send the first distance threshold to the terminal, so that the terminal determines the target TN area information that needs to be stored in the first TN area information. Terminal resources are prevented from being wasted, and applicability is high.

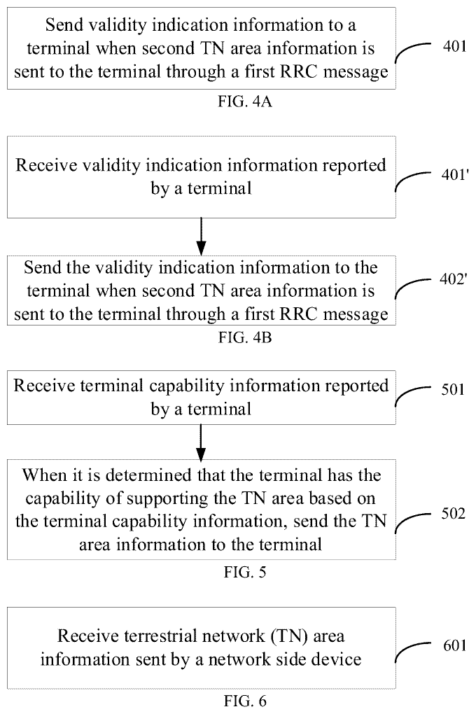

In some optional embodiments, referring to FIG. 4A, FIG. 4A is a flowchart of an information transmission method according to an embodiment, which may be performed by a network side device, where the network side device includes but is not limited to a base station, a core network device in an NTN, and the method may include a following step.

In step 401, validity indication information is sent to a terminal when second TN area information is sent to the terminal through a first RRC message.

In an embodiment of the present disclosure, the validity indication information indicates validity of the second TN area information.

In a possible implementation, the validity indication information includes at least one of: a valid duration of the second TN area information; and a second distance threshold used to determine a valid distance range of the second TN area information.

The terminal may determine validity of the second TN area information based on the validity indication information.

The valid duration may be used by the terminal to determine a maximum valid duration of the second TN area information.

The second distance threshold may be used by the terminal to determine a maximum movable distance value of the terminal relative to a second specified location when the second TN area information is valid. The second specified location is a geographic location where the terminal receives the second TN area information, or the second specified location is a geographic location where the terminal determines the second distance value, which is not limited in the present disclosure.

Correspondingly, when the valid duration is exceeded, the terminal may determine that the second TN area information is invalid. And/or, the terminal may determine the valid distance range of the second TN area information based on the second distance threshold, and when the terminal moves out of the valid distance range, it is determined that the second TN area information is invalid.

In the above embodiment, the network side device may send the validity indication information to the terminal, where the validity indication information indicates validity of the second TN area information configured by the network side device for the terminal. This improves reliability of determining the second TN area, and effectively reduces power consumption of the terminal.

In some optional embodiments, referring to FIG. 4B, FIG. 4B is a flowchart of an information transmission method according to an embodiment, which may be performed by a network side device, where the network side device includes but is not limited to a base station, a core network device in an NTN, and the method may include following steps 401′ and 402′.

In step 401′, validity indication information reported by a terminal is received.

In an embodiment of the present disclosure, the validity indication information indicates validity of the second TN area information.

In a possible implementation, the validity indication information includes at least one of: a valid duration of the second TN area information; and a second distance threshold used to determine a valid distance range of the second TN area information.

In an embodiment of the present disclosure, the terminal may determine the validity indication information based on terminal capability, and report the validity indication information to the network side device.

In step 402′, the validity indication information is sent to the terminal when second TN area information is sent to the terminal through a first RRC message.

In an embodiment of the present disclosure, the network side device may determine the validity indication information that is finally adopted based on the validity indication information reported by the terminal, and send the finally adopted validity indication information to the terminal.

For example, the terminal reports the validity indication information, and the validity indication information includes the valid duration, and the network side device may determine, based on the valid duration reported by the terminal, a shorter valid duration, and send the shorter valid duration to the terminal. Optionally, the network side device may send the valid duration reported by the terminal to the terminal as the valid duration of the second TN area information.

For another example, the terminal reports the validity indication information, and the validity indication information includes the valid duration, the network side device may use the valid duration reported by the terminal as the valid duration of the second TN area information, and the network side device may configure the second distance threshold for the terminal, and further send the valid duration and the second distance threshold to the terminal.

For another example, when the terminal reports the validity indication information, and the validity indication information includes the validity duration and the second distance threshold, the network side device may determine the validity duration of the second TN area information based on the validity duration reported by the terminal, where the validity duration determined by the network side device is less than or equal to the validity duration reported by the terminal. In addition, the network side device may determine the second distance threshold, where the second distance threshold determined by the network side device is less than or equal to the second distance threshold reported by the terminal. Further, the network side device sends the determined valid duration together with the second distance threshold to the terminal.

The above are merely examples for description, and any solution in which the terminal reports the validity indication information to assist the network side device in determining the validity of the second TN area information shall fall within the protection scope of the present disclosure.

In the above embodiment, the terminal may report the validity indication information based on the terminal capability, to assist the network side device in determining the validity indication information of the second TN area information. This improves reliability of the validity indication information.

In some optional embodiments, referring to FIG. 5, FIG. 5 is a flowchart of an information transmission method according to an embodiment, which may be performed by a network side device, where the network side device includes but is not limited to a base station, a core network device in an NTN, and the method may include following steps 501 and 502.

In step 501, terminal capability information reported by a terminal is received.

In an embodiment of the present disclosure, the terminal capability information indicates whether the terminal has capability of supporting a TN area.

In a possible implementation, the terminal capability information may further indicate a quantity of TN areas supported by the terminal.

In step 502, when it is determined that the terminal has the capability of supporting the TN area based on the terminal capability information, the TN area information is sent to the terminal.

In an embodiment of the present disclosure, when it is determined that the terminal has the capability of supporting the TN area based on the terminal capability information reported by the terminal, the network side device may send the TN area information to the terminal.

The network side device may send the TN area information to the terminal through the first system message and/or the first RRC message, and a quantity of pieces of sent TN area information may be determined based on the terminal capability information.

For example, the terminal capability information indicates that the terminal has the capability of supporting the TN area, and a quantity of supported TN areas is 4, and when determining, based on the terminal capability information, that the terminal has the capability of supporting the TN area, the network side device may send the first TN area information to the terminal through the first system message, and further, the network side device may send the second TN area information to the terminal through the first RRC message, where a quantity of second TN areas may be less than or equal to 4.

In the above embodiment, the network side device may receive the terminal capability information reported by the terminal, so as to configure and send the TN area information for the terminal based on the terminal capability, thereby improving reliability of TN area information configuration.

The following then describes the information transmission method provided in the present disclosure from a terminal side.

An embodiment of the present disclosure provides an information transmission method, as shown in FIG. 6, FIG. 6 is a flowchart of an information transmission method according to an embodiment, which may be performed by a terminal, and the method may include a following step.

In step 601, terrestrial network (TN) area information sent by a network side device is received.

In an embodiment of the present disclosure, the TN area information may refer to related information of an area covered by the TN network. The TN area information may include but is not limited to geographic location information of the TN area. The geographic location information may be represented by latitude and longitude, which is not limited in the present disclosure.

In a possible implementation, the TN area information may include geographic location information of a center point of each TN area and a radius of each TN area.

The terminal may use the center point as a circle center to determine a circular area by using a corresponding radius, and determine the circular area as a TN area.

In another possible implementation, the TN area information may include geographic location information of a plurality of location points located on a boundary of each TN area.

The terminal may connect the plurality of location points by using straight lines, and determine an obtained area as the TN area. That is, the terminal receives the plurality of pieces of location information sent by the network, to determine the TN area information.

The above is only an example description, and the TN area information may include other information for determining the TN area, which is not limited in the present disclosure.

In the above embodiments, the terminal can receive the TN area information sent by the network side device, such that the terminal performs, based on the TN area information, TN frequency measurement when the terminal is in the TN area, thereby effectively reducing power consumption of the terminal.

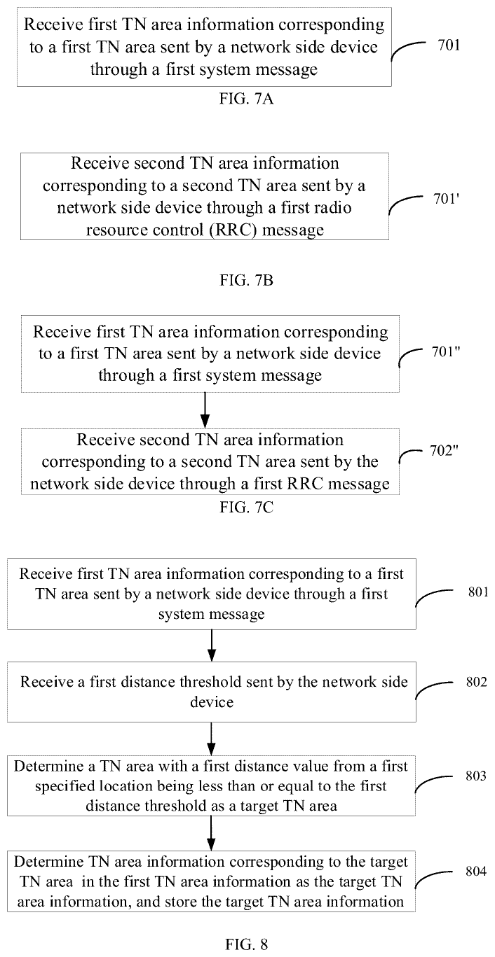

In some optional embodiments, as shown in FIG. 7A, FIG. 7A is a flowchart of an information transmission method according to an embodiment, which may be performed by a terminal, and the method may include a following step.

In step 701, first TN area information corresponding to a first TN area sent by a network side device through a first system message is received.

In the embodiment of the present disclosure, the first system message may be a system information block (SIB), such as a SIBn, where n is a positive integer.

There may be a plurality of first TN areas, which is not limited in the present disclosure.

In other words, the terminal may receive the first TN area information corresponding to the first TN area configured by the network side device in the NTN for the terminal through the first system message.

In a possible implementation, the first TN area information may include geographic location information of a center point of each first TN area and a radius of each first TN area.

In another possible implementation, the first TN area information may include geographic location information of a plurality of location points located on a boundary of each first TN area.

In the above embodiment, the terminal may receive the first TN area information sent by the network side device through the first system message, so that the terminal performs TN frequency measurement when the terminal is in the corresponding first TN area, thereby effectively reducing power consumption of the terminal.

In some optional embodiments, as shown in FIG. 7B, FIG. 7B is a flowchart of an information transmission method according to an embodiment, which may be performed by a terminal, and the method may include a following step.

In step 701′, second TN area information corresponding to a second TN area sent by a network side device through a first radio resource control (RRC) message is received.

In an embodiment of the present disclosure, the network side device may select some areas that are located around the terminal from the first TN areas according to the geographic location information of the terminal, that is, select second TN areas, and the terminal may receive the second TN area information corresponding to the second TN areas sent by the network side device through the first RRC message.

In the above embodiment, the terminal may receive the second TN area information sent by the network side device through the first RRC message, so that the terminal performs TN frequency measurement when the terminal is in the corresponding second TN area, thereby effectively reducing power consumption of the terminal.

In some optional embodiments, as shown in FIG. 7C, FIG. 7C is a flowchart of an information transmission method according to an embodiment, which may be performed by a terminal, and the method may include following steps 701″ and 702″.

In step 701″, first TN area information corresponding to a first TN area sent by a network side device through a first system message is received.

An implementation of step 701″ is similar to that of step 701, and details will not be repeated herein.

In step 702″, second TN area information corresponding to a second TN area sent by the network side device through a first RRC message is received.

An implementation of step 702″ is similar to that of step 701′, and details will not be repeated herein.

For the terminal, if both the first TN area information and the second TN area information are received, considering that the second TN area is located around the terminal, the terminal may preferentially use the second TN area information, that is, the terminal preferentially uses the second TN area information configured by the network side device for the terminal through the first RRC message.

If the terminal determines that the second TN area information is invalid, the terminal continues to use the first TN area information.

In the above embodiment, at first, the terminal may receive the first TN area information sent by the network side device through the first system message, and then, after establishing the RRC connection to the network side device, the terminal receives the second TN area information sent by the network side device through the first RRC message, so that the terminal performs TN frequency measurement when the terminal is in the corresponding second TN area, thereby effectively reducing power consumption of the terminal.

In some optional embodiments, as shown in FIG. 8, FIG. 8 is a flowchart of an information transmission method according to an embodiment, which may be performed by a terminal, and the method may include following steps 801-804.

In step 801, first TN area information corresponding to a first TN area sent by a network side device through a first system message is received.

An implementation of step 801 is similar to that of step 201, and details will not be repeated herein.

In step 802, a first distance threshold sent by the network side device is received.

The first distance threshold is used by the terminal to determine, in the first TN area information, target TN area information that needs to be stored.

In an embodiment of the present disclosure, in order to reduce occupation of terminal resources, the network side device may further configure a first distance threshold for the terminal and send the first distance threshold to the terminal, and the terminal may determine, according to the first distance threshold, target TN area information to be stored by the terminal in the received first TN area information.

In a possible implementation, the terminal may receive the first distance threshold sent by the network side device through a second system message.

Optionally, the second system message and the first system message may be a same SIB or different SIBs, for example, the first system message is SIB1, and the second system message may be SIBm, where m is greater than 1. For another example, both the first system message and the second system message are SIB1.

In another possible implementation, the terminal may receive the first distance threshold sent by the network side device through a second RRC message.

Optionally, the second RRC message and the first RRC message are a same RRC message or different RRC messages, which is not limited in the present disclosure.

In step 803, a TN area with a first distance value from a first specified location being less than or equal to the first distance threshold is determined as a target TN area.

In an embodiment of the present disclosure, the terminal may determine a TN area with a first distance value from a first specified location being less than or equal to the first distance threshold as a target TN area.

The first specified location may be a geographic location at which the terminal receives the first TN area information.

Optionally, the first specified location is a geographic location at which the terminal determines the first distance value.

In step 804, TN area information corresponding to the target TN area in the first TN area information is determined as the target TN area information, and the target TN area information is stored.

In an embodiment of the present disclosure, the terminal determines, in the first TN area information, the TN area information corresponding to the target TN area as the target TN area information, and stores the target TN area information.

In the above embodiment, the terminal may determine, based on the first distance threshold sent by the network side device, the target TN area information that needs to be stored in the first TN area information. Terminal resources are prevented from being wasted, and applicability is high.

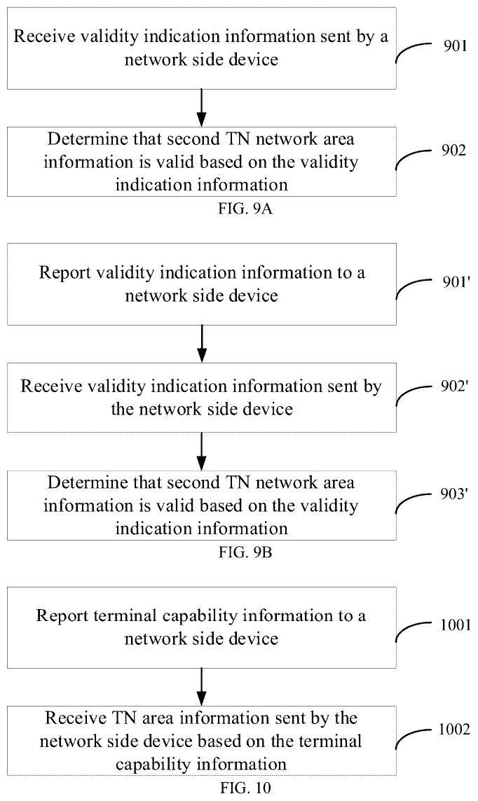

In some optional embodiments, as shown in FIG. 9A, FIG. 9A is a flowchart of an information transmission method according to an embodiment, which may be performed by a terminal, and the method may include following steps 901 and 902.

In step 901, validity indication information sent by a network side device is received.

In an embodiment of the present disclosure, when the terminal receives the second TN area information sent by the network side device through the first RRC message, the terminal may further receive validity indication information sent by the network side device. The validity indication information indicates validity of the second TN area information.

In a possible implementation, the validity indication information includes at least one of: a valid duration of the second TN area information; and a second distance threshold used to determine a valid distance range of the second TN area information.

The valid duration may be used by the terminal to determine a maximum valid duration of the second TN area information.

The second distance threshold may be used by the terminal to determine a maximum movable distance value of the terminal relative to a second specified location when the second TN area information is valid. The second specified location is a geographic location where the terminal receives the second TN area information, or the second specified location is a geographic location where the terminal determines the second distance value, which is not limited in the present disclosure.

Step 902, second TN network area information is determined to be valid based on the validity indication information.

In a possible implementation, the terminal may determine, within the valid duration, that the second TN network area information is valid.

In another possible implementation, the terminal may determine a valid distance range of the second TN area information based on the second distance threshold, and determine, when moving within the valid distance range, that the second TN area information is valid.

The terminal determines a range in which a second distance value between the terminal and a second specified location is less than or equal to the second distance threshold as the valid distance range. The second specified location is a geographic location where the terminal receives the second TN area information, or the second specified location is a geographic location where the terminal determines the second distance value.

In a possible implementation, the terminal determines that the second TN area information is valid may refers to that the terminal determines that the second TN area information is available.

Correspondingly, when determining that the valid duration of the second TN area information is exceeded, the terminal determines that the second TN area information is invalid. And/or, when determining that the valid distance range of the second TN area information is exceeded, the terminal determines that the second TN area information is invalid.

In the above embodiment, the terminal may receive the validity indication information sent by the network side device, to accurately determine validity of the second TN area information, thereby effectively reducing power consumption of the terminal.

In some optional embodiments, as shown in FIG. 9B, FIG. 9B is a flowchart of an information transmission method according to an embodiment, which may be performed by a terminal, and the method may include following steps 901′-903′.

In step 901′, validity indication information is reported to a network side device.

In an embodiment of the present disclosure, the validity indication information indicates validity of the second TN area information.

In a possible implementation, the validity indication information includes at least one of: a valid duration of the second TN area information; and a second distance threshold used to determine a valid distance range of the second TN area information.

In an embodiment of the present disclosure, the terminal may determine the validity indication information based on terminal capability, and report the validity indication information to the network side device.

In step 902′, validity indication information sent by the network side device is received.

In an embodiment of the present disclosure, the network side device may determine the validity indication information that is finally adopted based on the validity indication information reported by the terminal, and send the finally adopted validity indication information to the terminal.

In step 903′, second TN network area information is determined to be valid based on the validity indication information.

An implementation of step 903′ is similar to that of step 902, and details will not be repeated herein.

In the above embodiment, the terminal may report the validity indication information based on the terminal capability, to assist the network side device in determining the validity indication information of the second TN area information, so as to determine that the second TN area information is valid. This improves reliability of determining the second TN area.

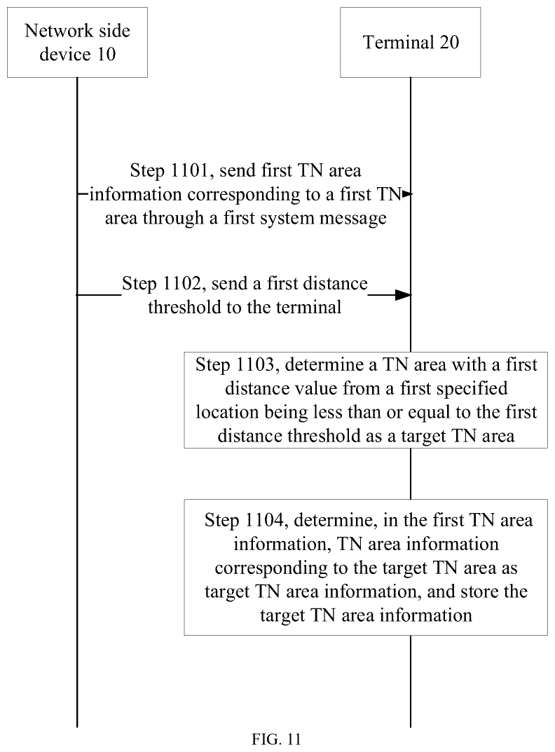

In some optional embodiments, as shown in FIG. 10, FIG. 10 is a flowchart of an information transmission method according to an embodiment, which may be performed by a terminal, and the method may include following steps 1001 and 1002.

In step 1001, terminal capability information is reported to a network side device.

In an embodiment of the present disclosure, the terminal capability information indicates whether the terminal has capability of supporting a TN area.

In a possible implementation, the terminal capability information may further indicate a quantity of TN areas supported by the terminal.

In step 1002, TN area information sent by the network side device based on the terminal capability information is received.

In an embodiment of the present disclosure, when it is determined that the terminal has the capability of supporting the TN area based on the terminal capability information reported by the terminal, the network side device may send the TN area information to the terminal.

The network side device may send the TN area information to the terminal through the first system message and/or the first RRC message, and a quantity of pieces of sent TN area information may be determined based on the terminal capability information reported by the terminal.

In the above embodiment, the terminal may report the terminal capability information to the network side device, to receive the TN area information configured and sent by the network side device for the terminal based on the terminal capability, thereby improving reliability of TN area information configuration.

In some optional embodiments, referring to FIG. 11, FIG. 11 is a flowchart of an information transmission method according to an embodiment, and the method may include following steps 1101-1104.

In step 1101, a network side device 10 sends first TN area information corresponding to a first TN area to a terminal 20 through a first system message.

An implementation of step 1101 is similar to that of step 201, and details will not be repeated herein.

In step 1102, the network side device sends a first distance threshold to the terminal.

An implementation of step 1102 is similar to that of step 302, and details will not be repeated herein.

In step 1103, the terminal determines a TN area with a first distance value from a first specified location being less than or equal to the first distance threshold as a target TN area.

An implementation of step 1103 is similar to that of step 803, and details will not be repeated herein.

In step 1104, the terminal determines, in the first TN area information, TN area information corresponding to the target TN area as target TN area information, and stores the target TN area information.

An implementation of step 1104 is similar to that of step 804, and details will not be repeated herein.

In the above embodiment, the network side device may configure the first TN area information for the terminal through the first system message, and the network side device may send the first distance threshold to the terminal; and the terminal determines, based on the first distance threshold, the target TN area information that needs to be stored in the first TN area information. This can prevent terminal resources from being wasted, and terminal power consumption is effectively reduced.

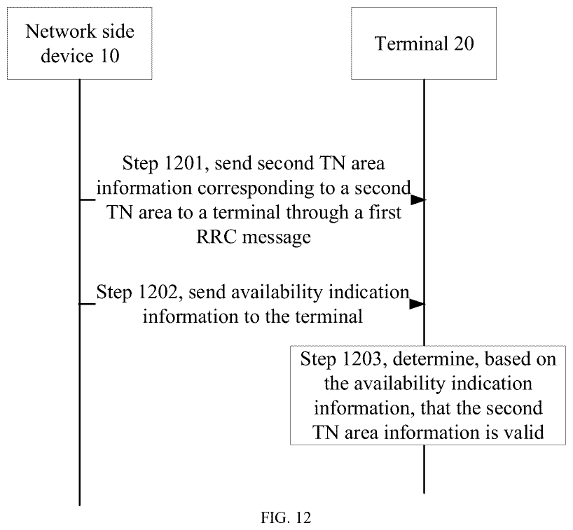

In some optional embodiments, referring to FIG. 12, FIG. 12 is a flowchart of an information transmission method according to an embodiment, and the method may include following steps 1201-1203.

In step 1201, a network side device sends second TN area information corresponding to a second TN area to a terminal through a first RRC message.

An implementation of step 1201 is similar to that of step 201′, and details will not be repeated herein.

In step 1202, the network side device sends availability indication information to the terminal.

An implementation of step 1202 is similar to that of step 401, and details will not be repeated herein.

In step 1203, the terminal determines, based on the availability indication information, that the second TN area information is valid.

An implementation of step 1203 is similar to that of step 902, and details will not be repeated herein.

In the above embodiment, the network side device may configure the second TN area information for the terminal through the first RRC message, and at the same time, the network side device may send the validity indication information to the terminal, and the terminal determines, based on the validity indication information, that the second TN area information is valid. This can prevent terminal resources from being wasted, and terminal power consumption is effectively reduced.

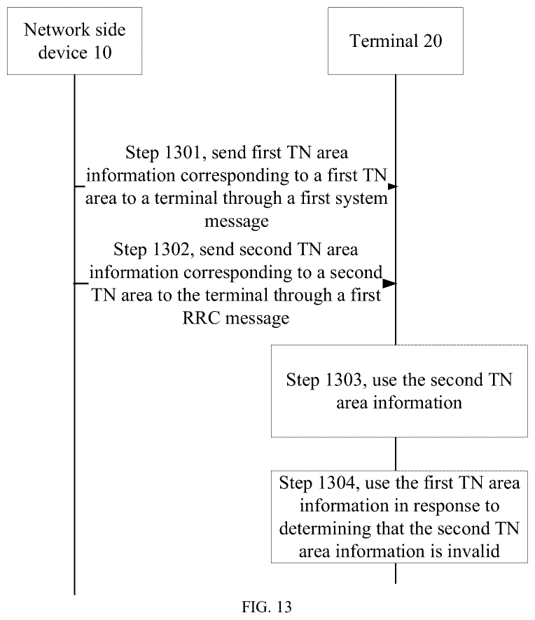

In some optional embodiments, referring to FIG. 13, FIG. 13 is a flowchart of an information transmission method according to an embodiment, and the method may include following steps 1301-1304.

In step 1301, a network side device sends first TN area information corresponding to a first TN area to a terminal through a first system message.

An implementation of step 1301 is similar to that of step 201, and details will not be repeated herein.

In step 1302, the network side device sends second TN area information corresponding to a second TN area to the terminal through a first RRC message.

An implementation of step 1302 is similar to that of step 201′, and details will not be repeated herein.

In step 1303, the terminal uses the second TN area information.

In the embodiment of the present disclosure, if both the first TN area information and the second TN area information are received, considering that the second TN area is located around the terminal, the terminal may preferentially use the second TN area information, that is, the terminal preferentially uses the second TN area information configured by the network side device for the terminal through the first RRC message.

In step 1304, the terminal uses the first TN area information in response to determining that the second TN area information is invalid.

If the terminal determines that the second TN area information is invalid, the terminal continues to use the first TN area information.

In the above embodiment, the terminal may receive both the first TN area information and the second TN area information sent by the network side device, and the terminal flexibly selects the TN area information to be used, thereby reducing power consumption of the terminal.

Corresponding to the above embodiments of information transmission method, the present disclosure further provides embodiments of an information transmission apparatus.

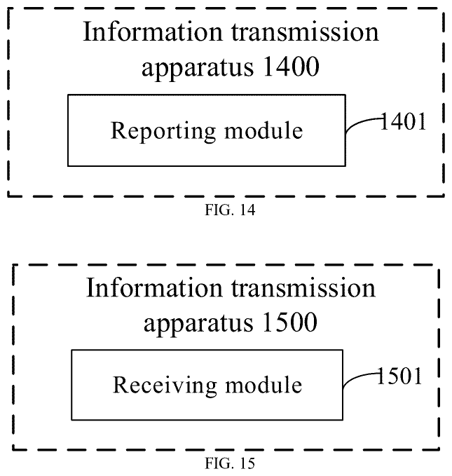

Referring to FIG. 14, FIG. 14 is a block diagram of an information transmission apparatus 1400 according to an example embodiment. The apparatus is applied to a base station, and includes:
a sending module 1401, configured to send terrestrial network (TN) area information to a terminal.

Referring to FIG. 15, FIG. 15 is a block diagram of an information transmission apparatus 1500 according to an example embodiment. The apparatus is applied to a terminal, and includes:
a receiving module 1501, configured to receive terrestrial network (TN) area information sent by a network side device.

For the apparatus embodiments, as they basically correspond to the method embodiments, relevant parts can be referred from the description of the method embodiments. The apparatus embodiments described above are merely illustrative, where the units described as separate components may or may not be physically separated, and the components displayed as units may or may not be physical units, that is, may be located in one place, or may be distributed on a plurality of network units. Some or all of the modules may be selected according to actual needs to achieve the objectives of the solutions of the present disclosure. A person of ordinary skill in the art may understand and implement the embodiments of the present disclosure without making creative efforts.

Correspondingly, the present disclosure further provides a computer-readable storage medium storing a computer program, where the computer program is used for performing the information transmission method for the terminal side described above.

Correspondingly, the present disclosure further provides a computer-readable storage medium storing a computer program, where the computer program is used for performing the information transmission method for the network side device described above.

Correspondingly, the present disclosure further provides an information transmission device, including:
a processor;
a memory for storing a processor-executable instruction;
where the processor is configured to perform the information transmission method according to any one of the above terminal side.

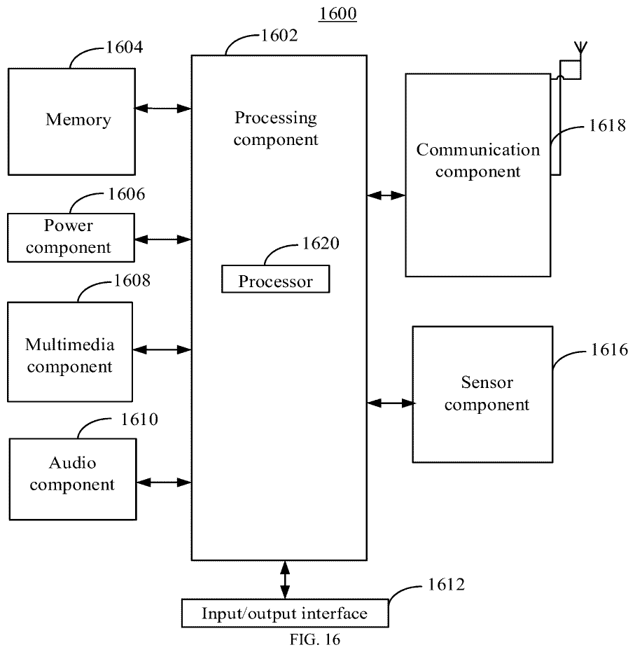

FIG. 16 is a block diagram of an information transmission device 1600 according to an example embodiment. For example, the device 1600 may be a terminal such as a mobile phone, a tablet computer, an e-book reader, a multimedia playback device, a wearable device, vehicle-mounted user equipment, an iPad, or a smart television.

Referring to FIG. 16, the device 1600 may include one or more of the following components: a processing component 1602, a memory 1604, a power component 1606, a multimedia component 1608, an audio component 1610, an input/output (I/O) interface 1612, a sensor component 1616, and a communication component 1618.

The processing component 1602 typically controls overall operations of the device 1600, such as the operations associated with display, telephone calls, data random access, camera operations, and recording operations. The processing component 1602 may include one or more processors 1620 to execute instructions to perform all or part of the steps in the above information transmission method. Moreover, the processing component 1602 may include one or more modules which facilitate the interaction between the processing component 1602 and other components. For example, the processing component 1602 may include a multimedia module to facilitate the interaction between the multimedia component 1608 and the processing component 1602. For another example, the processing component 1602 may read executable instructions from the memory to implement the steps of the information transmission method provided by the above embodiments.

The memory 1604 is configured to store various types of data to support the operation of the device 1600. Examples of such data include instructions for any applications or methods operated on the device 1600, contact data, phonebook data, messages, pictures, video, etc. The memory 1604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1606 provides power to various components of the device 1600. The power component 1606 may include a power management system, one or more power sources, and any other components associated with the generation, management, and distribution of power in the device 1600.

The multimedia component 1608 includes a display screen providing an output interface between the device 1600 and the user. In some embodiments, the multimedia component 1608 includes a front camera and/or a rear camera. The front camera and the rear camera may receive an external multimedia datum while the device 1600 is in an operation mode, such as a photographing mode or a video mode. Each of the front camera and the rear camera may be a fixed optical lens system or have focal length and optical zoom capability.

The audio component 1610 is configured to output and/or input audio signals. For example, the audio component 1610 includes a microphone (MIC) configured to receive an external audio signal when the device 1600 is in an operation mode, such as a call mode, a recording mode, and a voice recognition mode. The received audio signal may be further stored in the memory 1604 or transmitted via the communication component 1618. In some embodiments, the audio component 1610 further includes a speaker to output audio signals.

The I/O interface 1612 provides an interface between the processing component 1602 and peripheral interface modules, such as a keyboard, a click wheel, buttons, and the like. These buttons may include, but are not limited to, home buttons, volume buttons, start buttons, and lock buttons.

The sensor component 1616 includes one or more sensors to provide status assessments of various aspects of the device 1600. For instance, the sensor component 1616 may detect an open/closed status of the device 1600, relative positioning of components, e.g., the display and the keypad, of the device 1600, a change in position of the device 1600 or a component of the device 1600, a presence or absence of user contact with the device 1600, an orientation or an acceleration/deceleration of the device 1600, and a change in temperature of the device 1600. The sensor component 1616 may include a proximity sensor configured to detect the presence of nearby objects without requiring any physical contact. The sensor component 1616 may also include a light sensor, such as a CMOS or CCD image sensor, for use in imaging applications. In some embodiments, the sensor component 1616 may also include an accelerometer sensor, a gyroscope sensor, a magnetic sensor, a pressure sensor, or a temperature sensor.

The communication component 1618 is configured to facilitate communication, wired or wirelessly, between the device 1600 and other devices. The device 1600 can access a wireless network based on a communication standard, such as Wi-Fi, 2G, 3G, 4G, 5G or 6G, or a combination thereof. In an example embodiment, the communication component 1618 receives a broadcast signal or broadcast associated information from an external broadcast management system via a broadcast channel. In an example embodiment, the communication component 1618 further includes a near field communication (NFC) module to facilitate short-range communications. For example, NFC modules may be implemented based on radio frequency identification (RFID) technology, infrared data association (IrDA) technology, ultra-wideband (UWB) technology, Bluetooth (BT) technology, and other technologies.

In an example embodiment, the device 1600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing any of the above information transmission methods on the terminal side.

In an example embodiment, there is also provided a non-transitory machine-readable storage medium including instructions, such as included in the memory 1604, executable by the processor 1620 in the device 1600, for performing the above-described methods for transmitting information. For example, the non-transitory computer-readable storage medium may be a ROM (read-only memory), a RAM (random access memory), CD-ROM (compact disc read-only memory), magnetic tape, floppy disk, optical data storage device, or the like.

Correspondingly, the present disclosure further provides an information transmission device, including:
a processor;
a memory for storing a processor-executable instruction;
where the processor is configured to perform the information transmission method according to any one of the above network side device.

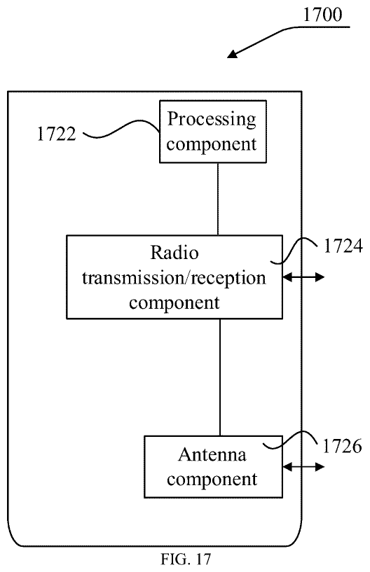

FIG. 17 is a schematic structural diagram of an information transmission device 1700 according to an example embodiment. The device 1700 may be provided as a network side device. Referring to FIG. 17, the device 1700 includes a processing component 1722, a radio transmission/reception component 1724, an antenna component 1726, and a signal processing portion specific to a radio interface, and the processing component 1722 may further include at least one processor.

One of the processors in the processing component 1722 may be configured to perform any of the information transmission methods described above on the network side device.

Other embodiments of the present disclosure will be apparent to those skilled in the art from consideration of the specification and practice of the present disclosure disclosed herein. The present disclosure is intended to cover any variations, uses, or adaptations of the present disclosure following the general principles thereof and including such departures from the present disclosure as come within known or customary practice in the art. It is intended that the specification and examples be considered as examples only, with a true scope and spirit of the disclosure being indicated by the following claims.

It should be understood that the present disclosure is not limited to the precise structures described above and shown in the accompanying drawings, and various modifications and changes may be made without departing from the scope thereof. The scope of the present disclosure is limited only by the appended claims.

1. An information transmission method, performed by a network side device, comprising:
sending terrestrial network (TN) area information to a terminal, wherein the TN area information comprises information of an area covered by a TN network.

2. The method according to claim 1, wherein sending the TN area information to the terminal comprises at least one of:
sending first TN area information corresponding to a first TN area to the terminal through a first system message; and/or
sending second TN area information corresponding to a second TN area to the terminal through a first radio resource control (RRC) message.

3. The method according to claim 2, further comprising:
sending a first distance threshold to the terminal, wherein the first distance threshold is configured by the terminal to determine, in the first TN area information, target TN area information that needs to be stored.

4. The method according to claim 3, wherein sending the first distance threshold to the terminal comprises at least one of:
sending the first distance threshold to the terminal through a second system message; or
sending the first distance threshold to the terminal through a second RRC message.

5. The method according to claim 2, further comprising:
when the second TN area information is sent to the terminal through the first RRC message, sending validity indication information to the terminal, wherein the validity indication information indicates validity of the second TN area information.

6. The method according to claim 5, further comprising:
receiving the validity indication information reported by the terminal.

7. The method according to claim 5, wherein the validity indication information comprises at least one of:
a valid duration of the second TN area information; or
a second distance threshold for determining a valid distance range of the second TN area information; wherein the second distance threshold is configured by the terminal to determine a maximum movable distance value relative to a second specified location when the second TN area information is valid.

8. The method according to claim 1, further comprising:
receiving terminal capability information reported by the terminal, wherein the terminal capability information indicates whether the terminal has capability of supporting a TN area.

9. The method according to claim 8, wherein the terminal capability information further indicates a quantity of TN areas supported by the terminal.

10. An information transmission method, performed by a terminal, comprising:
receiving terrestrial network (TN) area information sent by a network side device, wherein the TN area information comprises information of an area covered by a TN network.

11. The method according to claim 10, wherein receiving the TN area information sent by the network side device comprises at least one of:
receiving first TN area information corresponding to a first TN area sent by the network side device through a first system message; or
receiving second TN area information corresponding to a second TN area sent by the network side device through a first radio resource control (RRC) message.

12. The method according to claim 11, further comprising:
receiving a first distance threshold sent by the network side device, wherein the first distance threshold is configured by the terminal to determine, in the first TN area information, target TN area information that needs to be stored.

13. The method according to claim 12, further comprising:
determining a TN area with a first distance value from a first specified location being less than or equal to the first distance threshold as a target TN area; wherein the first specified location is a geographic location of the terminal when receiving the first TN area information, or the first specified location is a geographic location of the terminal when determining the first distance value; and
determining, in the first TN area information, TN area information corresponding to the target TN area as the target TN area information, and storing the target TN area information.

14. The method according to claim 12, wherein receiving the first distance threshold sent by the network side device comprises at least one of:
receiving the first distance threshold sent by the network side device through a second system message; or
receiving the first distance threshold sent by the network side device through a second RRC message.

15. The method according to claim 11, further comprising:
receiving validity indication information sent by the network side device, wherein the validity indication information indicates validity of the second TN area information;
wherein the method further comprises:
reporting the validity indication information to the network side device.

16. (canceled)

17. The method according to claim 15, wherein the validity indication information comprises at least one of:
a valid duration of the second TN area information; or
a second distance threshold for determining a valid distance range of the second TN area information; wherein the second distance threshold is used by the terminal to determine a maximum movable distance value relative to a second specified location when the second TN area information is valid;
wherein the method further comprises:
determining that the second TN area information is valid within the valid duration; or
determining a range with a second distance value from the second specified location being less than or equal to the second distance threshold as the valid distance range; wherein the second specified location is a geographic location of the terminal when receiving the second TN area information, or the second specified location is a geographic location of the terminal when determining the second distance value; and
determining that the second TN area information is valid when moving within the valid distance range;
wherein determining that the second TN area information is valid comprises:
determining that the second TN area information is available.

18-20. (canceled)

21. The method according to claim 11, further comprising:
in response to receiving the first TN area information and the second TN area information, using the second TN area information;
wherein the method further comprises:
in response to determining that the second TN area information is invalid, using the first TN area information;
wherein determining that the second TN area information is invalid comprises at least one of:
determining that a valid duration of the second TN area information is exceeded; or
determining that a valid distance range of the second TN area information is exceeded.

22-23. (canceled)

24. The method according to claim 10, further comprising:
reporting terminal capability information to the network side device, wherein the terminal capability information indicates whether the terminal has capability of supporting a TN area;
and the terminal capability information further indicates a quantity of TN areas supported by the terminal.

25-27. (canceled)

28. A non-transitory computer-readable storage medium, wherein the storage medium stores a computer program, and the computer program is used for performing the information transmission method according to claim 1.

29. An information transmission device, comprising:
a processor;
a memory for storing a processor-executable instruction;
wherein the processor is configured to perform the information transmission method according to claim 1.
